(19) United States
(12) Patent Application Publication
(10) Pub. No.: US 2013/0305031 A1
(43) Pub. Date: Nov. 14, 2013

(54) DIGITAL CONTROL DEVICE AND EXECUTION METHOD THEREOF

(71) Applicants: Yoshiyuki Nitta, Tokyo (JP); Yukitaka Yoshida, Tokyo (JP); Hirotaka Sakai, Tokyo (JP); Tomonari Ishizaka, Tokyo (JP); Susumu Yoshizawa, Tokyo (JP); Yoshito Sameda, Kanagawa (JP); Atsushi Kojima, Tokyo (JP); Mamoru Kato, Kanagawa (JP); Toshifumi Hayashi, Kanagawa (JP)

(72) Inventors: Yoshiyuki Nitta, Tokyo (JP); Yukitaka Yoshida, Tokyo (JP); Hirotaka Sakai, Tokyo (JP); Tomonari Ishizaka, Tokyo (JP); Susumu Yoshizawa, Tokyo (JP); Yoshito Sameda, Kanagawa (JP); Atsushi Kojima, Tokyo (JP); Mamoru Kato, Kanagawa (JP); Toshifumi Hayashi, Kanagawa (JP)

(73) Assignee: Kabushiki Kaisha Toshiba, Minato-ku (JP)

(21) Appl. No.: 13/980,361

(22) PCT Filed: Jan. 31, 2012
(86) PCT No.: PCT/JP2012/000623

§ 371 Date: Jul. 18, 2013

(30) Foreign Application Priority Data
Jan. 31, 2011 (JP) 2011-019229

(51) Int. Cl. G06F 9/44

(52) U.S. Cl. CPC G06F 9/441
USPC 713/100

(57) ABSTRACT

In a digital control device, when a normal mode for carrying out a normal process is selected by a mode switch, a computation unit transfers base process code and APL process code which controls the normal process from a code storage device to a main memory, loads the base process code and the APL process code which are transferred to the main memory, and carries out the normal process. When a test mode for carrying out a test process is selected by the mode switch, the computation unit transfers the base process code and test process code which controls the test process from the code storage device to the main memory, loads the base process code and the test process code which are transferred to the main memory, and carries out the test process.

### TECHNICAL FIELD

The present invention relates to a digital control device for carrying out a normal process and a test process of a controlled target device, and an execution method thereof.

### BACKGROUND ART

In large-scale plants such as a nuclear power plant, a thermal power plant and a chemical plant, various devices for monitoring or controlling facilities in the plants, such as temperature sensors, pressure sensors, limit switches, and actuators are provided. A digital control device is connected to these sensors and actuators as controlled target devices. As a normal process for a controlled target device, the digital control device transmits an operating instruction of the controlled target device as a process output so as to cause the controlled target device to operate and receives an operation result from the controlled target device as a process input so as to control and monitor the controlled target device. Further, some digital control devices are connected to an external computation device, and as the normal process, they transmit, as a process output, data to be transmitted to and stored in the external computation device, and receive, as a process input, data to be received from the external computation device and stored therein.

As a test for the controlled target device connected to the digital control device, checking of all patterns in a memory, forcible output of a digital output, forcible light emission of an optical module, loop-back verification of a transmission process, uncorrected input of an analog substrate, and the like are carried out. Conventionally, the test for the controlled target device is carried out such that an operator directly gives a test signal or a simulation signal to the controlled target device in a site where the controlled target device is provided, and checks a response therefrom. This causes an increase in costs of time and effort.

In view of this, there has been developed such a technique that a digital control device is configured such that a normal mode and a test mode are switchable so as to automatically carry out a normal process of a controlled target device when the normal mode is selected, while carrying out a test process of transmitting a simulation signal to the controlled target device and checking a response therefrom when the test mode is selected (see, for example, Patent Document 1).

Further, such a technique has been developed that a normal control code and a debugging code of a digital substrate are stored respectively in a general control ROM (Read Only Memory) and in a debugging ROM, so that a computation unit reads the normal control code from the general control ROM to use the normal control code in the normal mode, while the computation unit reads the debugging code from the debugging ROM to use the debugging code in the debugging mode. Thus, codes for the normal mode time and for the debugging mode are independent from each other (see, for example, Patent Document 2).

Furthermore, such a technique has been developed that an address value of a program to be read at the time of power activation is specified by a rotary switch which is able to select a normal process and a test process, and based on the address, an application program or a maintenance program is selectively read from a nonvolatile storage section to a storage section and started (see, for example, Patent Document 3).

### PRIOR ART DOCUMENTS

### Patent Documents

Patent Document 1: Japanese Patent Application Laid-Open No. 2008-146440
Patent Document 2: Japanese Patent Application Laid-Open No. 11-65884
Patent Document 3: Japanese Patent Application Laid-Open No. 2009-169496

### SUMMARY OF THE INVENTION

### Problems to be Solved by the Invention

Conventionally, in order to carry out the technique described in Patent Document 1, at the time of power activation of the digital control device, a code in which a code for carrying out the test process in the test mode is incorporated in a code for carrying out the normal process in the normal mode is transferred to the main memory so as to be read by the computation unit, and a part in the code for carrying out the normal process is used in the normal mode and a part in the code for carrying out the test process is used in the test mode so as to control the controlled target device in general.

However, in plants including a nuclear power plant which are required to be highly reliable, it is necessary for a code of a digital control device for controlling a controlled target device to be surely verified in terms of consistency to a design requirement for the code and stability of the code, and further, verification of validity of the code by a third party, so-called V & V (Verification & Validation), may be also required in some cases.

Accordingly, in a verification operation of the code of the digital control device to which the technique described in Patent Document 1, it is necessary to verify an influence of the code part used in the test mode with respect to the code part used in the normal mode, which causes an increase in costs of effort and time.

Further, in the technique of Patent Document 2, the computation unit does not use the debugging code in the normal mode, but respective codes are stored in the debugging ROM and the general control ROM and a switchover circuit switches a ROM from which the computation unit reads a code. Therefore, it is difficult to apply the technique to a general digital control device constituted by an existing computation unit and an existing main memory. Furthermore, since the switchover circuit is complicated, there is a problem with reliability.

Further, an operating system (an OS) for carrying out a base process is necessary for execution of an application program and a maintenance program. In the technique of Patent Document 3, if respective operating systems (OS) for carrying out a base process are incorporated in the application program and in the maintenance program so as to selectively read a program, costs of consistency verification and soundness verification of the two operating systems increase.

In view of this, an object of the present invention is to provide a digital control device which prevents a code to be used in a test mode from affecting a process in a normal mode, with a simple configuration.

### Means for Solving the Problem

In order to achieve the object, according to the present invention, there is presented a digital control device comprising: a mode switch capable of selecting either of a normal mode for carrying out a normal process and a test mode for carrying out a test process; a code storage device for storing a base process code, an application process code for controlling the normal process, and a test process code for controlling the test process; a main memory capable of receiving and storing codes transferred from the code storage device; a boot process code storage memory for storing a boot process code indicative of a code to be transferred from the code storage device to the main memory in each of the normal mode and the test mode; and a computation unit for reading the boot process code from the boot process code storage memory after power activation, wherein: when the normal mode is selected by the mode switch, the computation unit causes the base process code and the application process code to be transferred to the main memory by use of the boot process code, so that the computation unit reads the base process code and the application process code thus transferred to the main memory and carries out the normal process, and when the test mode is selected by the mode switch, the computation unit causes the base process code and the test process code to be transferred to the main memory by use of the boot process code, so that the computation unit reads the base process code and the test process code thus transferred to the main memory and carries out the test process.

According to the present invention, there is also presented an execution method of a digital control device, comprising: a step of selecting, by a mode switch, either of a normal mode for carrying out a normal process and a test mode for carrying out a test process; a step of, when the normal mode is selected by the mode switch, a computation unit causing a base process code and an application process code for controlling the normal process to be transferred to a main memory from a code storage device so as to carry out the normal process by reading the base process code and the application process code thus transferred to the main memory; and a step of, when the test mode is selected by the mode switch, the computation unit causing the base process code and a test process code for controlling the test process, to be transferred to the main memory from the code storage device so as to carry out the test process by reading the base process code and the test process code thus transferred to the main memory.

### Advantageous Effect of the Invention

According to the present invention, in a digital control device, it is possible to prevent a code to be use in a test mode from affecting a process in a normal mode, with a simple configuration.

### BRIEF DESCRIPTION OF THE DRAWINGS

FIG. 1 is a schematic block diagram illustrating an operation in a normal mode of a digital control device according to a first embodiment of the present invention.

FIG. 2 is a schematic block diagram illustrating an operation in a test mode of the digital control device according to the first embodiment of the present invention.

FIG. 3 is a schematic block diagram illustrating an operation in an APL (application) test mode of a digital control device according to a second embodiment of the present invention.

FIG. 4 is a schematic block diagram illustrating an operation in a test mode of a digital control device according to a third embodiment of the present invention.

FIG. 5 is a schematic block diagram illustrating an operation in an APL test mode of the digital control device according to the third embodiment of the present invention.

FIG. 6 is a schematic block diagram illustrating an operation in a normal mode of the digital control device according to the third embodiment of the present invention.

### EMBODIMENTS FOR CARRYING OUT THE INVENTION

Embodiments of a digital control device according to the present invention are described.

### First Embodiment

### Configuration

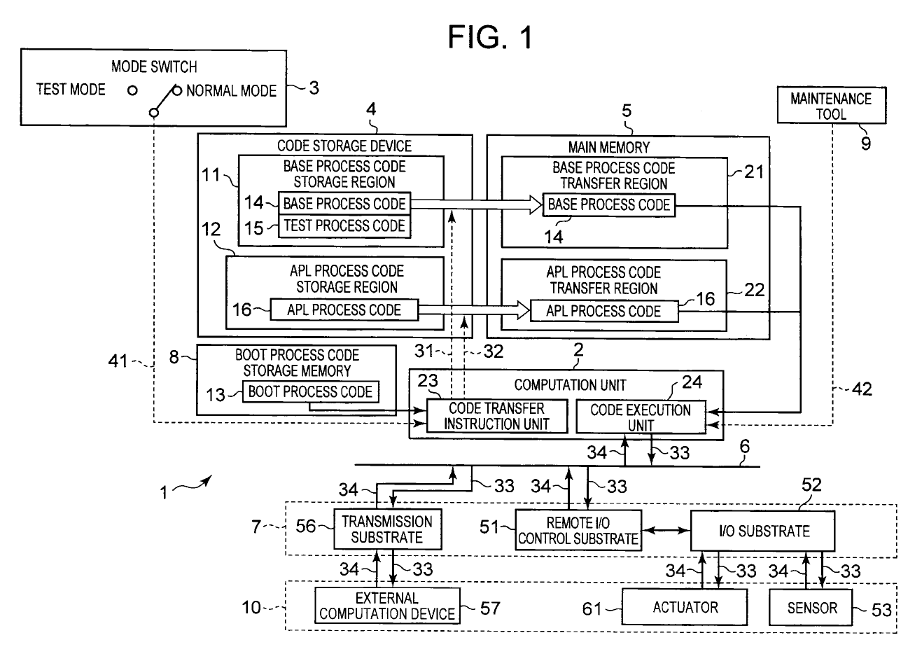

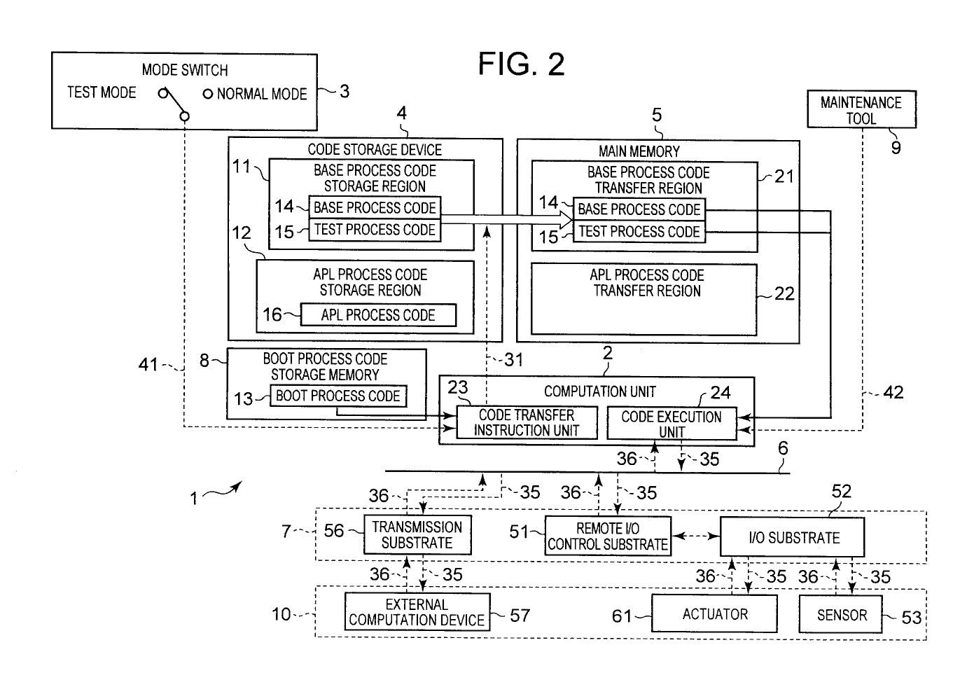

The following describes a digital control device according to a first embodiment of the present invention with reference to FIGS. 1 and 2. FIG. 1 is a schematic block diagram illustrating an operation in a normal mode of the digital control device according to the first embodiment of the present invention. FIG. 2 is a schematic block diagram illustrating an operation in a test mode of the digital control device according to the first embodiment of the present invention.

A digital control device 1 includes a computation unit 2, a mode switch 3, a code storage device 4, a main memory 5, an I/O bus 6, a signal I/O device 7, a boot process code storage memory 8, and a maintenance tool 9. Moreover, a controlled target devices 10 are connected to the digital control device 1.

Here, it is possible to apply, to the main memory 5, a memory which is used as a primary storage device for a general computer and which enables high speed access, such as an SRAM (Static Random Access Memory) or a DRAM (Dynamic Random Access Memory). The computation unit 2 is a device for reading data in the main memory 5, carrying out a computation by use of the data, and carrying out input and output of a signal with an apparatus externally connected thereto, and a CPU (Central Processing Unit) processor of a general computer is applicable to the main memory 5.

The code storage device 4 is a storage device used as an auxiliary memory device for a general computer and capable of storing data therein even after loss of power. An HDD (Hard Disc Drive) or a magnetic disk is also applicable, but it is desirable to apply a nonvolatile memory such as FLASH memory or EPROM (Erasable Programmable Read Only Memory) having a high resistance against vibration and a long durable period. Further, the boot process code storage memory 8 is a memory to which a nonvolatile memory such as OTPROM (One Time Programmable Read Only Memory) or EPROM is applied and to which the computation unit 2 is able to access after power activation of the digital control device 1.

The mode switch 3 is a switch which is able to select either of the normal mode and the test mode, and it is possible to apply thereto a manual switch or a switch via a touch panel on a CRT monitor. Further, the mode switch 3 is able to transmit a mode select signal 41 indicating that the normal mode or the test mode has been selected. Moreover, the maintenance tool 9 is a device which is able to transmit a process content specification signal 42, which will be described later.

The signal I/O device 7 is a device which is able to transmit to and receive from the controlled target device 10 a normal process output 33 and a normal process input 34 as illustrated in FIG. 1 and further which is able to transmit to and receive from the controlled target device 10 a test process output 35 and a test process input 36 as illustrated in FIG. 2.

Further, the controlled target device 10 is a device which is able to carry out a normal process by receiving a normal process output 33 from the signal I/O device 7 and transmitting a normal process input 34 to the signal I/O device 7 as illustrated in FIG. 1. Further, as illustrated in FIG. 2, the controlled target device 10 is able to carry out a test process such that the controlled target device 10 carries out a test operation by receiving a test process output 35 from the signal I/O device 7 and transmits a result of the test operation as a test process input to the signal I/O device 7. Specific configurations of the signal I/O device 7 and the controlled target device 10 and specific operations of the normal process and the test process will be described later.

The computation unit 2 is constituted by a code transfer instruction unit 23 and a code execution unit 24. Further, the code storage device 4 includes therein a base process code storage region 11 and an application process code storage region 12 (hereinafter referred to as an APL process code storage region 12). Furthermore, the main memory 5 includes therein a base process code transfer region 21 and an application process code transfer region 22 (hereinafter referred to as an APL process code transfer region 22).

Before power activation of the digital control device 1, a base process code 14 and a test process code 15 are stored in the base process code storage region 11 of the code storage device 4 in advance. Further, an application process code 16 (hereinafter referred to as an APL process code 16) is stored in the APL process code storage region 12 of the code storage device 4 in advance. Moreover, a boot process code 13 is stored in the boot process code storage memory 8 in advance. Further, before power activation of the digital control device 1, any of the aforementioned codes are not stored in the main memory 5.

The following describes connection relations between respective constituents in the digital control device 1. The mode switch 3 is connected to the code transfer instruction unit 23 of the computation unit so that the mode switch 3 is able to transmit a mode select signal 41 to the code transfer instruction unit 23 of the computation unit 2.

The code storage device 4 is connected to the code transfer instruction unit 23 of the computation unit 2 so that the code storage device 4 is able to receive a base process code transfer instruction 31 and an APL process code transfer instruction 32 from the code transfer instruction unit 23 of the computation unit 2.

The code storage device 4 is connected to the main memory 5 so that the code storage device 4 is able to transfer, to the base process code transfer region 21 of the main memory 5, a code instructed to be transferred by the after-mentioned base process code transfer instruction 31 out of the base process code 14 and the test process code 15 in the base process code storage region 11, and further the code storage device 4 is able to transfer, to the APL process code transfer region 22 of the main memory 5, the APL process code 16 in the APL process code storage region 12 when it is specified as a code that should be transferred by the after-mentioned APL process code transfer instruction 32.

The main memory 5 is connected to the code execution unit 24 of the computation unit 2 so that the main memory 5 causes the code execution unit 24 of the computation unit 2 to read a code transferred into the base process code transfer region 21 out of the base process code 14 and the test process code 15, and further, when the APL process code 16 is transferred into the APL process code transfer region 22, the main memory 5 is able to cause the code execution unit 24 of the computation unit 2 to read the APL process code 16.

The boot process code storage memory 8 is connected to the code transfer instruction unit 23 of the computation unit 2 so that the code transfer instruction unit 23 of the computation unit 2 is able to read the boot process code 13. The maintenance tool 9 is connected to the code execution unit 24 of the computation unit 2 so that the maintenance tool 9 is able to transmit a process content specification signal 42 to the code execution unit 24 of the computation unit 2.

The I/O bus 6 is a device for transmitting a normal process output 33 and a test process output 35 transmitted from the code execution unit 24 of the computation unit 2 to respectively corresponding constituent devices of the signal I/O device 7 and further for gathering a normal process input 34 and a test process input 36 transmitted from the respective constituent devices of the signal I/O device 7 and transmitting them to the code execution unit 24 of the computation unit 2.

The signal I/O device 7 is a device for converting a normal process output 33 and a test process output 35 transmitted from the code execution unit 24 of the computation unit 2 into formats adapting to reception of a corresponding controlled target device 10. Further, the signal I/O device 7 is a device for converting a normal process input 34 and a test process input 36 transmitted from the controlled target device 10 into formats adapting to reception of the code execution unit 24 of the computation unit 2.

The code execution unit 24 of the computation unit 2 is connected to the controlled target device 10 via the I/O bus 6 and the signal I/O device 7 so that, in the normal mode illustrated in FIG. 1, the code execution unit 24 of the computation unit 2 is able to transmit a normal process output 33 to the controlled target device 10 via the I/O bus 6 and the signal I/O device 7 and to receive a normal process input 34 from the controlled target device 10 via the I/O bus 6 and the signal I/O device 7.

Further, the code execution unit 24 of the computation unit 2 is connected to the controlled target device 10 via the I/O bus 6 and the signal I/O device 7 so that in the test mode illustrated in FIG. 2, the code execution unit 24 of the computation unit 2 is able to transmit a test process output 35 to the controlled target device 10 via the I/O bus 6 and the signal I/O device 7 and to receive a test process input 36 from the controlled target device 10 via the I/O bus 6 and the signal I/O device 7.

(Operation)

The following describes an operation of the first embodiment of the present invention. Initially described is an operation when the normal mode is selected by the mode switch 3. Here, the normal mode is a mode to carry out a normal process of the controlled target device 10. The normal process of the controlled target device 10 is a process for causing the controlled target device 10 to perform an original object and a function by the digital control device 1. For example, in a case where the controlled target device 10 is a temperature sensor for monitoring facilities of a power generation plant, the normal process corresponds to a case where a temperature of the facilities is measured by the temperature sensor at normal operation of the power generation plant and the digital control device 1 monitors and records a result of the measurement.

In the normal process, the code execution unit 24 of the computation unit 2 transmits a normal process output 33 to the controlled target device 10. The normal process output 33 includes operation information of the controlled target device 10, information to be stored in the controlled target device 10 or other devices connected to the controlled target device 10, and the like. The controlled target device 10 carries out an operation by the normal process output 33, transmission of the normal process output 33 to other devices, recording of the normal process output 33, and the like.

Further, in the normal process, the controlled target device 10 transmits a normal process input 34 to the code execution unit 24 of the computation unit 2. The normal process input 34 includes a computation instruction to the code execution unit 24, information to be stored in the code execution unit 24 or other devices connected thereto, and the like. The code execution unit 24 of the computation unit 2 carries out a computation according to the normal process input 34, transmission of the normal process input 34 to other devices, recording of the normal process input 34, and the like.

When power activation of the digital control device 1 is carried out in a state where the normal mode is selected by the mode switch 3, the code transfer instruction unit 23 of the computation unit 2 reads a boot process code 13 stored in the boot process code storage memory 8. Here, the boot process code 13 is a code for carrying out a boot process of starting the digital control device 1 and causing the digital control device 1 to operate the normal mode or the test mode. BIOS (Basic Input/Output System) in a general computer corresponds to this.

In the boot process, a starting process of starting devices constituting the digital control device 1 and a code transfer process of transferring codes stored in the code storage device 4 to the main memory 5 are carried out. Thus, information for the starting process is stored in the boot process code 13, and storage positions of respective codes stored in the code storage device 4 and information for specifying codes which should be transferred from the code storage device 4 to the main memory 5 in a selected mode are also stored therein.

Here, codes which should be transferred from the code storage device 4 to the main memory 5 in the normal mode are the base process code 14 and the APL process code 16. Further, codes which should be transferred from the code storage device 4 to the main memory 5 in the test mode are the base process code 14 and the test process code 15.

When the normal mode is selected by the mode switch 3, a mode select signal 41 indicating that the normal mode has been selected is transmitted to the code transfer instruction unit 23 of the computation unit 2. The code transfer instruction unit 23 of the computation unit 2 carries out a code transfer process of transferring a code to be used in the normal mode to the main memory 5 by use of the mode select signal 41 indicating that the normal mode has been selected and the boot process code 13.

The code transfer process is carried out together with the starting process or after the starting process. Further, such a function to inspect validity of the codes in the code storage device 4 before the code transfer process is carried out may be provided. When there is abnormality in the validity of the code at this time, the digital control device 1 is irregularly stopped without carrying out the code transfer process.

In the code transfer process, the code transfer instruction unit 23 of the computation unit 2 transmits a base process code transfer instruction 31 to transfer the base process code 14 stored in the base process code storage region 11 of the code storage device 4, to the base process code transfer region 21 in the main memory 5. Upon reception of the base process code transfer instruction 31 as described above, the code storage device 4 transfers the base process code 14 to the base process code transfer region 21 in the main memory 5 so that the base process code 14 is stored therein.

Further, in the code transfer process, the code transfer instruction unit 23 of the computation unit 2 transmits an APL process code transfer instruction 31 to transfer the APL process code 16 stored in the APL process code storage region 12 of the code storage device 4, to the APL process code transfer region 22 in the main memory 5. Upon reception of the APL process code transfer instruction 32 as described above, the code storage device 4 transfers the APL process code 16 to the APL process code transfer region 22 in the main memory 5 so that the APL process code 16 is stored therein.

When the code transfer process in the normal mode is finished, the code execution unit 24 of the computation unit 2 reads the base process code 14 and the APL process code 16 in the main memory 5. Here, in the normal process of the controlled target device 10, the base process code 14 is a code for controlling and monitoring a basic operation of a device constituting the digital control device 1 and is a basic code for causing the APL process code 16 to work in the digital control device 1. An operating system in a general computer corresponds to the base process code 14.

Further, the APL process code 16 is a code for controlling a specific process in the normal process. The APL process code 16 stores therein information indicative of a controlled target device 10 to which a normal process output 33 is transmittable, information indicative of a specific content of the normal process output 33 which is transmittable to the controlled target device 10, and the like. The specific content of the normal process output 33 is a signal to be an instruction in an operation according to the normal process input 34 of the controlled target device 10, information which should be transmitted at the time of transmission of the normal process input 34 of the controlled target device 10 to other devices, and information indicative of recorded data or the like at the time of recording of the normal process input 34 of the controlled target device 10. Software working by an operating system in a general computer corresponds to the APL process code 16.

The maintenance tool 9 transmits a process content specification signal 42 to the code execution unit 24 of the computation unit 2. The process content specification signal 42 is a signal for specifying a normal process output 33 to be actually transmitted, out of normal process outputs 33 which the APL process code 16 is able to transmit. For example, controlled target devices 10 to which the APL process code 16 is able to transmit the normal process output 33 are narrowed down to specify a controlled target device 10 to which the normal process output 33 is actually transmitted, and further, specific contents of the normal process output 33 which the APL process code 16 is able to transmit are narrowed down to specify a content to be actually transmitted. Specification of the normal process output 33 by the maintenance tool 9 may be manually carried out by an operator or may be automatically carried out by inputting an operation plan and the like into the maintenance tool 9.

The code execution unit 24 of the computation unit 2 transmits the normal process output 33 to the signal I/O device 7 via the I/O bus 6 by use of the APL process code 16 and the process content specification signal 42. A specific example of the normal process output 33 will be described later.

The signal I/O device 7 carries out amplification, digital-analogue conversion, protocol conversion, and the like with respect to the normal process output 33 received from the code execution unit 24 of the computation unit 2 so as to convert the normal process output 33 into a signal adapting to reception of a connected controlled target device 10, and transmits the normal process output 33 thus converted to the controlled target device 10. The controlled target device 10 receives the normal process output 33 from the signal I/O device 7 and carries out an operation according to the normal process output 33, recording of the normal process output 33, transmission of the normal process output 33 to other devices, and the like.

Further, the controlled target device 10 transmits a normal process input 34 to the signal I/O device 7. The signal I/O device 7 receives the normal process input 34 from the controlled target device 10, converts the normal process input 34 so as to adapt to reception of the code execution unit 24 of the computation unit 2, and transmits the normal process input 34 thus converted, to the code execution unit 24 of the computation unit 2. The code execution unit 24 of the computation unit 2 receives the normal process input 34 from the signal I/O device 7, and carries out a computation according to the normal process input 34 by use of the APL process code 16, transmission of the normal process input 34 to other devices, recording of the normal process input 34, and the like. At this time, the process content specification signal 42 for specifying a process content of the normal process input 34 by the code execution unit 24 may be transmitted to the code execution unit 24 by the maintenance tool 9.

Note that recording of the normal process input 34 is carried out by recording by a storage device connected to the code execution unit 24 of the computation unit 2 or by a storage device connected in a signal path from the controlled target device 10 to the code execution unit 24 of the computation unit 2.

A specific example of the normal process of the controlled target device 10 in the digital control device 1 is described below. First of all, the following deals with a case where the controlled target device 10 is a sensor 53 and an actuator 61, and the signal I/O device 7 is constituted by a remote I/O control substrate 51 and an I/O substrate 52 controlled by the remote I/O control substrate 51. The remote I/O control substrate 51 and the I/O substrate 52 are connected via an optical cable.

The normal process in this case is to cause the sensor 53 to carry out a measurement and the actuator 61 to operate, and to receive, by the code execution unit 24, a result of the measurement of the sensor 53 and a result of the operation of the actuator 61 so as to carry out monitoring. The code execution unit 24 of the computation unit 2 causes the sensor 53, which constitutes part of the controlled target device 10, to carry out a measurement and transmits as a normal process output 33 a signal to be an instruction to cause the actuator 61 to operate to the remote I/O control substrate 51 in a form of an electrical signal.

The remote I/O control substrate 51 converts the normal process output 33 in the form of the electrical signal into an optical signal and transmits it to the I/O substrate 52. The I/O substrate 52 receives the normal process output 33 thus converted into the optical signal, further converts the normal process output 33 into forms adapting to reception of the sensor 53 and the actuator 61, and transmits them respectively to the sensor 53 and the actuator 61.

When receiving the normal process output 33 from the I/O substrate 52, the sensor 53 and the actuator 61 carry out a measurement and an operation, and transmit a result of the measurement and a result of the operation to the I/O substrate 52 as normal process inputs 34. The I/O substrate 52 converts the normal process inputs 34 into optical signals and transmits them to the remote I/O control substrate 51. The remote I/O control substrate 51 converts the normal process inputs 34 in the form of the optical signals into electrical signals adapting to reception of the computation unit 2, and transmits them to the code execution unit 24 of the computation unit 2. The code execution unit 24 of the computation unit 2 receives the normal process inputs 34 in the form of the electrical signals, and carries out monitoring and recording of a result of the measurement of the sensor 53 and a result of the operation of the actuator 61.

Next will be described a case where the controlled target device 10 is an external computation device 57 for transmitting and receiving data to/from the digital control device 1 and the signal I/O device 7 is a transmission substrate 56 for mediating transmission and reception of a signal between the digital control device 1 and the external computation device 57. The normal process in this case is to transmit and receive data mutually between the digital control device 1 and the external computation device 57.

The code execution unit 24 of the computation unit 2 transmits data to be transmitted to and stored in the external computation device 57 as a normal process output 33. The transmission substrate 56, which is the signal I/O device 7, converts the normal process output 33 so as to adapt to reception of the external computation device 57 and transmits it to the external computation device 57. The external computation device 57 receives the normal process output 33 and stores it therein, and transmits data to be transmitted from the external computation device 57 to the digital control device 1 and stored therein, to the transmission substrate 56 as a normal process input 34. The transmission substrate 56 receives the normal process input 34 and converts it so as to adapt to reception of the code execution unit 24 of the computation unit 2, and the code execution unit 24 of the computation unit 2 receives the normal process input 34 thus converted, and stored it therein.

Note that the digital control device 1 can be configured so as not to transmit the normal process output 33 to the controlled target device 10 or not to receive the normal process input 34 from the controlled target device 10. For example, in a case where the controlled target device 10 is a sensor which is constantly operated, and is able to automatically transmit a result of a measurement as the normal process input 34, the code execution unit 24 does not need to transmit the normal process output 33, which will be an instruction for a measurement, to the controlled target device 10. Further, in a case where the controlled target device 10 is a storage device and transmits the normal process output 33 from the digital control device 1 to the controlled target device 10 in one direction, the digital control device 1 can be configured so as not to transmit the normal process input 34 to the digital control device 1.

As described above, in the normal mode, only the base process code 14 and the APL process code 16 are transferred from the code storage device 4 to the main memory 5, and they are read by the code execution unit 24 of the computation unit 2. Accordingly, in the normal process, the test process code 15 is not transferred from the code storage device 4 to the main memory 5 and read by the code execution unit 24 of the computation unit 2.

Next will be described an operation when the test mode is selected by the mode switch 3. Here, the test mode is a mode to carry out a test process of the controlled target device 10. For example, in a case where the controlled target device 10 is an optical sensor for monitoring facilities of a power generation plant, the test process corresponds such a case that, in a regular inspection of the power generation plant, a simulation optical signal is transmitted to the optical sensor and a response to the simulation optical signal is received from the optical sensor so as to check soundness of the optical sensor.

In the test process, when the code execution unit 24 of the computation unit 2 transmits a test process output 35 to the controlled target device 10, the controlled target device 10 carries out a test operation according to the test process output 35, as illustrated in FIG. 2. Further, when a result of the test operation of the controlled target device 10 is transmitted to the code execution unit 24 of the computation unit 2 as a test process input 36, the code execution unit 24 of the computation unit 2 carries out monitoring, abnormality judgment, recording, and the like by use of the test process input 36.

When power activation of the digital control device 1 is carried out in a state where the test mode is selected by the mode switch 3, the code transfer instruction unit 23 of the computation unit 2 reads the boot process code 13 stored in the boot process code storage memory 8. Further, a mode select signal 41 indicating that the test mode has been selected by the mode switch 3 is transmitted to the code transfer instruction unit 23 of the computation unit 2.

The code transfer instruction unit 23 of the computation unit 2 carries out codes transfer process of transferring a code to be used in the test mode to the main memory 5 by use of the mode select signal 41 indicating that the test mode has been selected and the boot process code 13.

In the code transfer process, the code transfer instruction unit 23 of the computation unit 2 transmits a base process code transfer instruction 31 to transfer the base process code 14 and the test process code 15 stored in the base process code storage region 11 of the code storage device 4 to the base process code transfer region 21 in the main memory 5. Upon reception of the base process code transfer instruction 31 as described above, the code storage device 4 transfers the base process code 14 and the test process code 15 to the base process code transfer region 21 in the main memory 5 so that they are stored therein.

When the code transfer process in the test mode is finished, the code execution unit 24 of the computation unit 2 reads the base process code 14 and the test process code 15 in the main memory 5. Here, in test process of the controlled target device 10, the base process code 14 is a code for controlling a transmission operation of the test process output 35 and a reception operation of the test process input 36.

Further, the test process code 15 is a code which works according to the base process code 14 and controls a specific process in the test process. The test process code 15 is a code for storing therein information indicative of a controlled target device 10 which is able to transmit a test process output 35, information indicative of a specific content of the test process output 35 which is transmittable, and the like. The specific content of the test process output 35 is information indicative of a signal to be an instruction to cause the controlled target device 10 to carry out a test operation, a method and a time of the test operation of the controlled target device 10, an intensity and a duration time of a simulation signal to carry out the test operation, and the like.

The maintenance tool 9 transmits a process content specification signal 42 to the code execution unit 24 of the computation unit 2. The process content specification signal 42 is a signal for specifying a test process output 35 to be actually transmitted, out of test process outputs 35 which the test process code 15 is able to transmit. For example, controlled target devices 10 to which the test process code 15 is able to transmit the test process output 35 are narrowed down to specify a controlled target device 10 to which the test process output 35 is actually transmitted, and further, specific contents of the test process output 35 which the test process code 15 is able to transmit are narrowed down to specify a content to be actually transmitted.

The code execution unit 24 of the computation unit 2 transmits a test process output 35 for carrying out a test process of the controlled target device 10 to the signal I/O device 7 via the I/O bus 6 by use of the test process code 15 and the process content specification signal 42. The signal I/O device 7 converts the test process output 35 received from the code execution unit 24 of the computation unit 2 into a signal adapting to reception of a connected controlled target device 10, and transmits the test process output 35 thus converted to the controlled target device 10.

The controlled target device 10 receives the test process output 35 from the signal I/O device 7, carries out a test operation, and transmits a result of the test operation as a test process input 36 to the signal I/O device 7. The signal I/O device 7 receives the test process input 36 from the controlled target device 10, converts the test process input 36 into a signal adapting to reception of the code execution unit 24 of the computation unit 2, and transmits the test process input 36 thus converted to the code execution unit 24 of the computation unit 2. The code execution unit 24 of the computation unit 2 receives the test process input 36 from the signal I/O device 7, and carries out an abnormal judgment of the controlled target device 10, recording of the test process input 36, and the like by use of the test process input 36.

Further, when power activation of the digital control device 1 is carried out and the digital control device 1 is changed into the test mode from a state where the digital control device 1 operates in the normal mode or the digital control device 1 is changed into the normal mode from a state where the digital control device 1 operates in the test mode, a boot process constituted by a starting process and a code transfer process is carried out by using the boot process code 13 again.

A specific example of the test process of the controlled target device 10 by the digital control device 1 is described below. First of all, the following deals with a case where the controlled target device 10 is a sensor 53 and an actuator 61, and the signal I/O device 7 is constituted by a remote I/O control substrate 51 and an I/O substrate 52. The remote I/O control substrate 51 and the I/O substrate 52 are connected via an optical cable. In the test process in this case, the sensor 53 is caused to measure a simulation signal and the result of the measurement of the simulation signal is received to carry out an abnormality judgment, and the actuator 61 is caused to carry out a test operation and a result of the test operation is received so as to carry out an abnormality judgment.

The code execution unit 24 of the computation unit 2 transmits a signal to be an instruction to cause the sensor 53 to carry out a measurement and a simulation signal targeted for the measurement to the remote I/O control substrate 51 as a test process output 35. Further, the code execution unit 24 of the computation unit 2 transmits a signal to be an instruction to cause the actuator 61 to carry out a test operation to the remote I/O control substrate 51 as a test process output 35. The remote I/O control substrate 51 converts the test process outputs 35 into optical signals and transmits them to the I/O substrate 52. The I/O substrate 52 converts the test process outputs 33 in a form of optical signals into forms adapted to reception of the sensor 53 and the actuator 61, and transmits them respectively to the sensor 53 and the actuator 61. The sensor 53 receives the test process output 35 and measures the simulation signal, and the actuator 61 receives the test process output 35 and carries out the test operation.

The sensor 53 transmits a result of the measurement of the simulation signal to the I/O substrate 52 as a test process input 36. Further, the actuator 61 transmits a result of the test operation to the I/O substrate 52 as a test process input 36. The I/O substrate 52 converts the test process inputs 36 into optical signals and transmits them to the remote I/O control substrate 51. The remote I/O control substrate 51 converts the test process inputs 36 in a form of optical signals into forms adapting to reception of the code execution unit 24 of the computation unit 2, and transmits them thereto. The code execution unit 24 of the computation unit 2 receives the test process inputs 36, and carries out an abnormality judgment on the result of the measurement of the simulation signal from the sensor 53 and an abnormality judgment on the result of the test operation from the actuator 61.

Further, in this configuration, it is also possible to carry out a test process on the I/O substrate 52 constituting the signal I/O device 7 as the controlled target device 10. The code execution unit 24 of the computation unit 2 transmits an instruction signal to causes an optical module of the I/O substrate 52 to forcibly emit light, to the remote I/O control substrate 51 as a test process output 35. The remote I/O control substrate 51 converts the test process output 35 into an optical signal and transmits it to the I/O substrate 52. The I/O substrate 52 receives the test process output 35 to cause the optical module to forcibly emit light, and transmits an optical signal of the forcible light emission, to the remote I/O control substrate 51 as a test process input 36. The remote I/O control substrate 51 converts the test process input 36 in a form of the optical signal into a form adapting to the code execution unit 24 of the computation unit 2, and transmits it thereto. The code execution unit 24 of the computation unit 2 receives the test process input 36, and carries out an abnormality judgment on and recording of a test operation result of the I/O substrate 52, which is the controlled target device 10.

Next will be described a case where the controlled target device 10 is an external computation device 57 and the signal I/O device 7 is a transmission substrate 56. In a test process in this case, a simulative computation signal is transmitted from the digital control device 1 to the external computation device 57 so as to cause the external computation device 57 to carry out a simulative computation, and a result of the simulative computation by the external computation device 57 is received so as to carry out an abnormality judgment, thereby checking soundness of the external computation device 57.

The code execution unit 24 of the computation unit 2 in the digital control device 1 transmits, to the transmission substrate 56, a simulative computation signal to the external computation device 57 as a test process output 35. The transmission substrate 56 converts the test process output 35 to a form adapting to reception of the external computation device 57 and transmits it to the external computation device 57.

The external computation device 57 receives the test process output 35 to carry out a simulative computation and transmits a result of the simulative computation to the transmission substrate 56 as a test process input 36. The transmission substrate 56 converts the test process input 36 into a form adapting to the code execution unit 24 of the computation unit 2. The code execution unit 24 of the computation unit 2 receives the test process input 36 thus converted from the transmission substrate 56, and carries out an abnormality judgment and recording by use of the result of the simulative computation by the external computation device 57.

(Effect)

According to the first embodiment of the present invention, in the normal mode, only the base process code 14 and the APL process code 16 are transferred to the main memory 5 to be read in the code execution unit 2 of the computation unit 2 and a normal process is carried out by use of the base process code 14 and the APL process code 16. Accordingly, it is possible to prevent an influence by the test process code 15 in the normal process, and it is possible to reduce time required for verification and inspection of validity of the codes in comparison with a case where the test process code 15 is incorporated in to the base process code 14. Further, since a switchover circuit is not used to transfer codes to be used in in the normal mode and in the test mode to the main memory 5, it is possible to apply the present embodiment to a general computer.

Further, by commonly using the base process code 14 to be used as an operating system (an OS) in the normal process and in the test process, consistency verification of the OS is unnecessary in comparison with a case where the OS is incorporated into respective codes used in the normal process and the test process, so that soundness verification of the OS is carried out at a minimum. Further, it is also possible to minimize a storage capacity of the OS in the code storage device 4.

Further, in a memory mapping to the main memory 5, an allocation region to the base process code 14, which is an OS, uses the same region at the time of the normal process and at the time of the test process. Particularly, a memory mapping in a nuclear power plant requires a static mapping to map specific data onto a specific region. In this regard, by always allocating the base process code 14 to the same region, verification and monitoring of an allocating state of the OS in the static mapping are easily carried out.

Further, by transferring the APL process code 16 to the APL process code transfer region 22, which is a region different from the base process code transfer region 21, and allocating it thereto, it is possible to stably secure a memory region for the static mapping independently from the base process code 14.

Note that the test process is not limited to the test operation of the controlled target device 10, but also includes processes which are not carried out in the normal process, such as a general test operation including a substrate check and a simulative computation of the digital control device 1 itself. Further, the normal process is not limited to monitoring and control of the controlled target device 10 connected to the digital control device 1, but also includes a computing process or a storage process to be carried out only in the digital control device 1.

### Second Embodiment

### Configuration

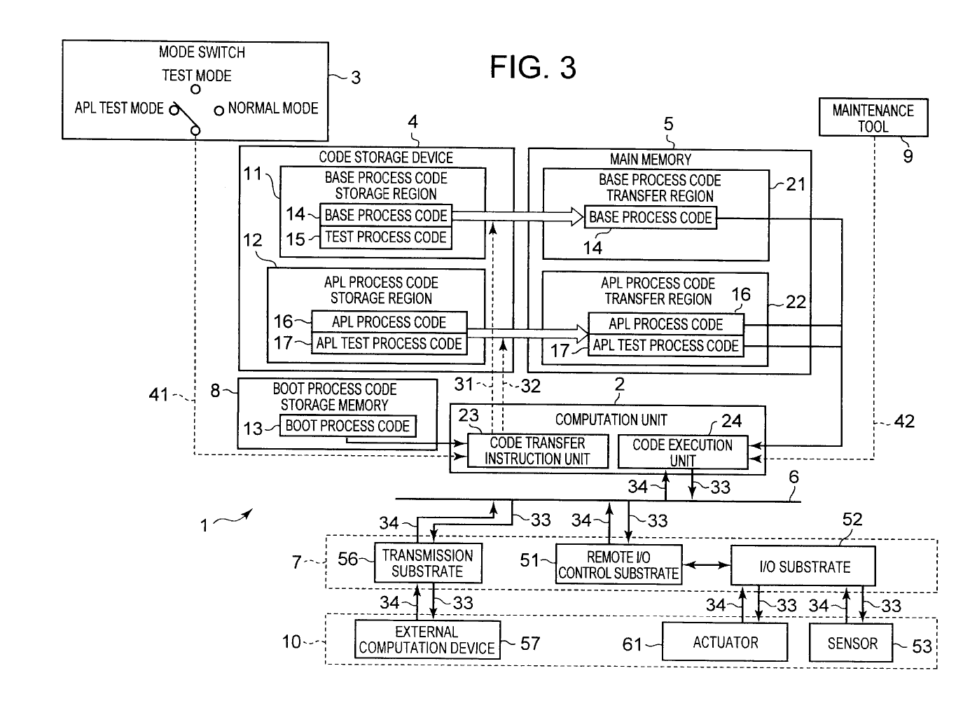

The following describes a digital control device according to a second embodiment of the present invention with reference to FIG. 3. The same reference numeral is attached to the same or similar part as/to each unit in the digital control device 1 according to the first embodiment and an explanation about the same configuration is omitted.

FIG. 3 is a schematic block diagram illustrating an operation in an application test mode (hereinafter referred to as an APL test mode) of the digital control device according to the second embodiment of the present invention. The second embodiment is different from the first embodiment in that an APL test mode is further provided in the mode switch 3, and an application test process code 17 (hereinafter referred to as an APL test process code 17) is further stored in the APL process code storage region 12 of the code storage device 4. Moreover, to the boot process code 13, information indicative of a storage position of the APL test process code 17 in the APL process code storage region 12 of the code storage device 4 is further added.

Note that when the digital control device 1 has a plurality of computation units 2, the plurality of computation units 2 may be connected to a single I/O bus 6 via external bridges or the like, so that signals can be transmitted and received between the plurality of computation units 2 and the signal I/O device 7 via the single I/O bus 6.

(Operation)

An operation of the second embodiment of the present invention is described below. Explanations about operations in the normal mode and the test mode are omitted, and the following describes an operation when the APL test mode is selected by a mode switch 3. Here, the APL test mode is a mode for carrying out an application test process (hereinafter referred to as an APL test process) of a controlled target device 10. The APL test process of the controlled target device 10 is to carry out an operation check and an abnormality judgment of a normal process of the controlled target device 10 by use of a base process code 14 and an APL process code 17. Accordingly, similarly to the operation in the normal mode, a normal process by transmission and reception of a normal process output 33 and a normal process input 34 is carried out between a computation unit 2 and the controlled target device 10.

When the APL test mode is selected by the mode switch 3, the mode switch 3 transmits a mode select signal 41 indicating that the APL test mode has been selected to a code transfer instruction unit 23 of the computation unit 2. The code transfer instruction unit 23 of the computation unit 2 transmits a base process code transfer instruction 31 to transfer the base process code 14 in a base process code storage region 11 of a code storage device 4 to a base process code transfer region 21 in a main memory 5 by use of a boot process code and the mode select signal 41. Upon reception of the base process code transfer instruction 31 described above, the code storage device 4 transfers the base process code 14 to the base process code transfer region 21 in the main memory 5 so that the base process code 14 is stored therein.

Further, the code transfer instruction unit 23 of the computation unit 2 transmits an APL process code transfer instruction 32 to transfer an APL process code 16 and an APL test process code 17 in an APL process code storage region 12 of the code storage device 4, to an APL process code transfer region 22 in the main memory 5. Upon reception of the APL process code transfer instruction 32 described above, the code storage device 4 transfers the APL process code 16 and the APL test process code 17 to the APL process code transfer region 22 in the main memory 5 so that they are stored therein.

When the code transfer process in the APL test mode is finished, the code execution unit 24 of the computation unit 2 reads the base process code 14, the APL process code 16, and the APL test process code 17 in the main memory 5. Here, the APL test process code 17 is a code which operates according to the base process code 14 and controls an operation check and an abnormality judgment on the normal process in the APL test process. The APL test process code 17 stores therein information indicative of a controlled target device 10 on which the operation check and the abnormality judgment are performable, a threshold value or a logic usable for the abnormality judgment, and the like.

The maintenance tool 9 transmits a process content specification signal 42 to the code execution unit 24 of the computation unit 2. Here, the process content specification signal 42 is a signal for specifying an operation check and an abnormality judgment to be actually carried out from among operation checks and abnormality judgments on the normal process which are performable by the APL process code 16. For example, it is possible to narrow down controlled target devices 10 on which the operation check and the abnormality judgment are performable to specify a controlled target device 10 on which the operation check and the abnormality judgment are actually carried out, and further to narrow down pieces of information indicative of threshold values and logics usable for the abnormality judgment to specify a threshold value and a logic which are actually used.

The code execution unit 24 of the computation unit 2 carries out the APL test process of the controlled target device 10 by use of the base process code 14, the APL process code 16, and the APL test process code 17 in the main memory 5, and the process content specification signal 42.

The APL test process of the controlled target device 10 is carried out such that the aforementioned normal process of the controlled target device 10 is carried out by use of the base process code 14, the APL process code 16, and the process content specification signal 42, and an abnormality judgment and recording of the normal process output 33 and the normal process input 34 to be transmitted and received in the normal process are carried out, thereby carrying out an operation check and an abnormality judgment on the normal process.

A specific example of the APL test process of the controlled target device 10 by the digital control device 1 is described below. The following deals with a case where the controlled target device 10 is a sensor 53, and the signal I/O device 7 is constituted by a remote I/O control substrate 51 and an I/O substrate 52 controlled by the remote I/O control substrate 51. Here, the remote I/O control substrate 51 and the I/O substrate 52 are connected via an optical cable.

The APL test process in this case is to cause the sensor 53 to carry out a measurement operation, and to receive a result of the measurement, thereby carrying out an operation check and an abnormality judgment of a series of normal processes to be monitored. The code execution unit 24 of the computation unit 2 transmits a normal process output 33 to cause the sensor 53, which is the control targeted device 10, to carry out a measurement, to the remote I/O control substrate 51 of the signal I/O device 7 in a form of an electrical signal.

The remote I/O control substrate 51 converts the normal process output 33 in a form of the electrical signal into an optical signal and transmits it to the I/O substrate 52. The I/O substrate 52 receives the normal process output 33 thus converted into the optical signal, and further converts the normal process output 33 into a form adapted to reception of the sensor 53.

Upon reception of the normal process output 33 from the I/O substrate 52, the sensor 53 carries out a measurement operation according to the normal process and transmits a result of the measurement to the I/O substrate 52 as a normal process input 34. The I/O substrate 52 converts the normal process input 34 into an optical signal and transmits it to the remote I/O control substrate 51. The remote I/O control substrate 51 converts the normal process input 34 in the form of the optical signal into an electrical signal adapting to the computation unit 2, and transmits it to the code execution unit 24 of the computation unit 2. The code execution unit 24 of the computation unit 2 receives the normal process input 34 in the form of the electrical signal, and carries out monitoring and recording of the result of the measurement of the sensor 53.

Further, the code execution unit 24 of the computation unit 2 carries out a check on a transmission content of the normal process output 33 and a check on a response time and a response content of the normal process input 34 with respect to the normal process output 33 by use of the APL test process code 17 and the process content specification signal 42.

Operations of the normal mode and the test mode in the present embodiment are carried out in a similar manner to the first embodiment. Accordingly, when the normal mode is selected, the APL test process code 17 is not transferred to the main memory 5, and therefore, the APL test process code 17 does not have an influence on the normal process of the controlled target device 10 in the normal mode.

(Effect)

According to the second embodiment of the present invention, the APL test mode is provided in the mode switch 3, the APL test process code 17 is further stored in the code storage device 4, and the APL test process code 17 is transferred to the main memory 5 only in the APL test mode so as to carry out the APL test process. This makes it possible to carry out an operation check and an abnormal judgment on the normal process of the controlled target device 10 and further to prevent the APL test process code 17 from having an influence on the normal process of the controlled target device 10 in the normal mode.

Note that it is also possible to configure the mode switch 3 such that the test mode and the APL test mode are provided as the same mode, and when the test mode is selected by the mode switch 3, the base process code 14, the test process code 15, the APL process code 16, and the APL test process code 17 are transferred to the main memory 5 from the code storage device, so that the test process and the APL test process of the controlled target device 10 are carried out at the same time.

### Third Embodiment

Configuration

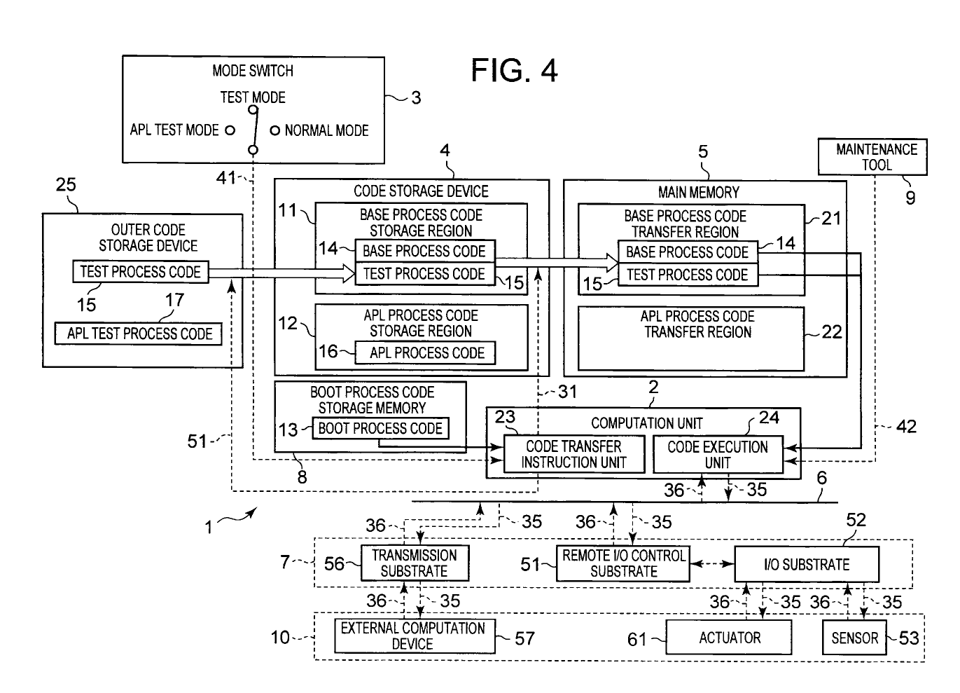

The following describes a digital control device according to a third embodiment of the present invention with reference to FIGS. 4 to 6. The same reference numeral is attached to the same or similar part as/to each unit in the digital control devices 1 according to the first and second embodiments and an explanation about the same configuration is omitted.

FIG. 4 is a schematic block diagram illustrating an operation in a test mode of the digital control device according to the third embodiment of the present invention. The third embodiment is different from the second embodiment in that a digital control device 1 according to the third embodiment includes an outer code storage device 25 as compared with the digital control device 1 according to the second embodiment.

The outer code storage device 25 stores therein a test process code 15 and an APL test process code 17. Further, the code transfer instruction unit 23 of the computation unit 2 is able to transmit a code storage instruction 37 to transfer a code in the outer code storage device 25 to the code storage device 4 so that the code is stored therein. Further, the code storage device 4 stores therein a base process code 14 and an APL process code 16, but does not store therein the test process code 15 nor the APL test process code 17 before power activation.

The outer code storage device 25 is connected to the code transfer instruction unit 23 of the computation unit 2 so that the outer code storage device 25 is able to receive a code storage instruction 37 from the code transfer instruction unit 23 of the computation unit 2. Further, the outer code storage device 25 is connected to the code transfer instruction unit 23 of the computation unit 2 so that the test process code 15 is able to transfer the text process code 15 to the base process code storage region 11 of the code storage device 4 so that the text process code 15 is stored therein, and further is able to transfer the APL test process code 17 to the APL process code storage region 12 of the code storage device 4 so that the APL test process code 17 is stored therein.

(Operation)

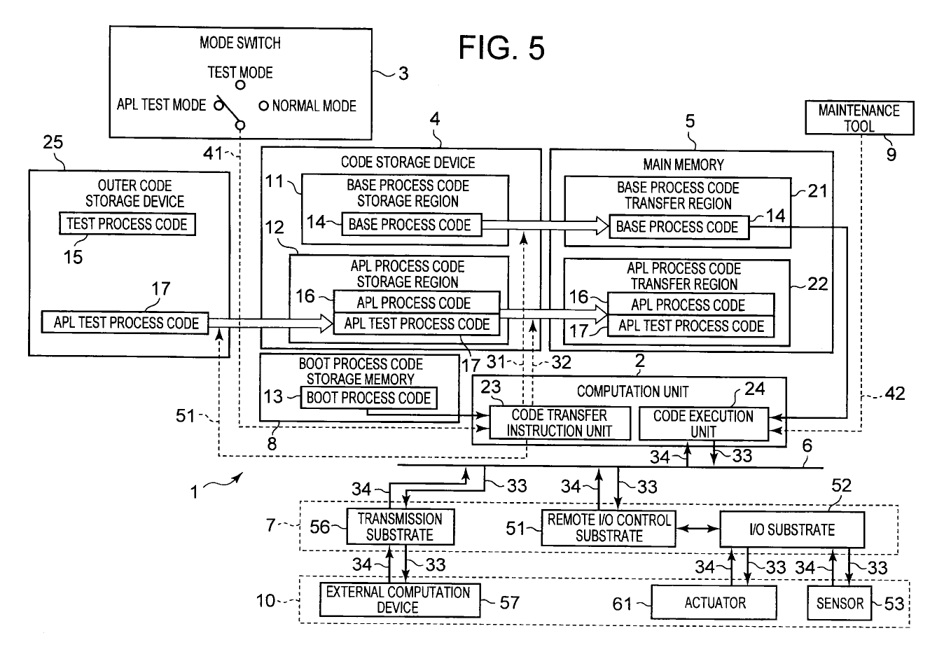

The following describes an operation of the third embodiment of the present invention. Initially described is an operation in the test mode of the digital control device 1. As illustrated in FIG. 5, when the test mode is selected by the mode switch 3, the code transfer instruction unit 23 of the computation unit 2 transmits, to the outer code storage device 25, a code storage instruction 37 to transfer the test process code 15 to the base process code storage region 11 of the code storage device 4 so that the test process code 15 is stored therein.

Upon reception of the code storage instruction 37, the outer code storage device 25 transfers the test process code 15 to the base process code storage region 11 of the code storage device 4 so that the test process code 15 is stored therein. When the storage of the test process code 15 in the code storage device 4 is finished, the code transfer instruction unit 23 of the computation unit 2 transmits, to the code storage device 4, a base process code transfer instruction 31 to transfer the base process code 14 and the test process code 15 to the main memory 5.

Upon reception of the base process code transfer instruction 31, the code storage device 4 transfers the base process code 14 and the test process code 15 to the main memory 5. When the transfer of the base process code 14 and the test process code 15 to the main memory 5 is finished, the code execution unit 2 of the computation unit 2 reads the base process code 14 and the test process code 15 and carries out a test process of the controlled target device 10 by use of these codes.

Next will be described an operation in the APL test mode of the digital control device 1. FIG. 5 is a schematic block diagram illustrating an operation in the APL test mode of the digital control device according to the third embodiment of the present invention. When the APL test mode is selected by the mode switch 3, the code transfer instruction unit 23 of the computation unit 2 transmits, to the outer code storage device 25, a code storage instruction 51 to transfer the APL test process code 17 to an APL process code storage region 12 of the code storage device 4 so that the APL test process code 17 is stored therein.

Upon reception of the code storage instruction 51, the outer code storage device 25 transfers the APL test process code 17 to the APL process code storage region 12 of the code storage device 4 so that the APL test process code 17 is stored therein. The code transfer instruction unit 23 of the computation unit 2 transmits, to the code storage device 4, a base process code transfer instruction 31 to transfer the base process code 14 to the main memory 5. Further, when the storage of the APL test process code 17 in the code storage device 4 is finished, the code transfer instruction unit 23 of the computation unit 2 transmits, to the code storage device 4, an APL process code transfer instruction 32 to transfer the APL process code 16 and the APL test process code 17 to the main memory 5.

Upon reception of the base process code transfer instruction 31, the code storage device 4 transfers the base process code 14 to the base process code transfer region 21 in the main memory 5. Further, upon reception of the APL process code transfer instruction 32, the code storage device 4 transfers the APL process code 16 and the APL test process code 17 to the APL process code transfer region 22 in the main memory 5.

When the transfer of the base process code 14, the APL process code 16, and the APL test process code 17 to the main memory 5 is finished, the code execution unit 24 of the computation unit 2 reads the base process code 14, the APL process code 16, and the APL test process code 17 and carries out the aforementioned APL test process of the controlled target device 10 by use of these codes.

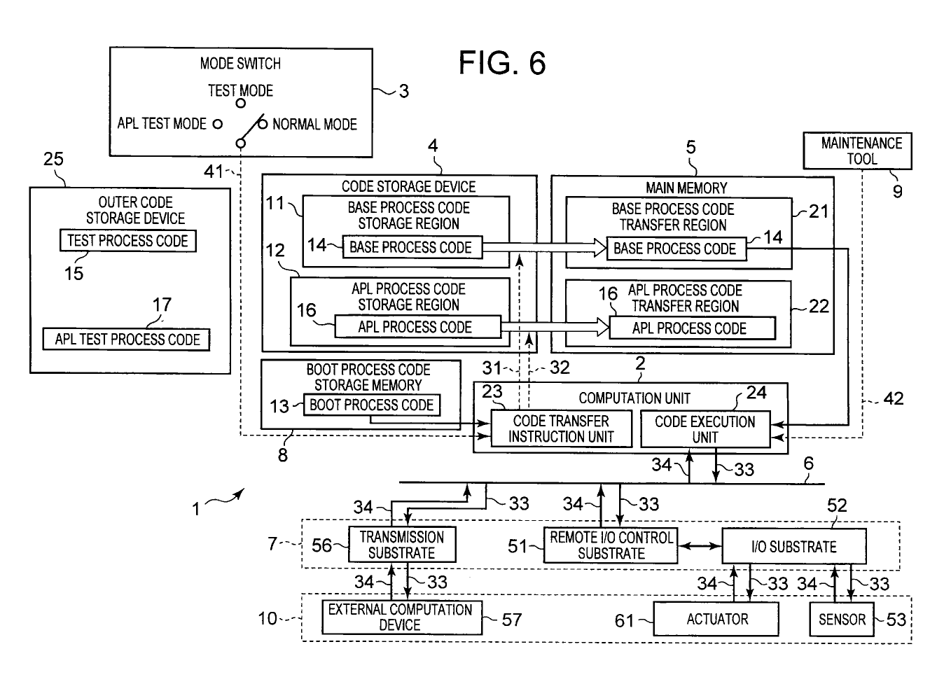

Finally described is an operation in the normal mode of the digital control device 1. FIG. 6 is a schematic block diagram illustrating an operation in the normal mode of the digital control device according to the third embodiment of the present invention. When the normal mode is selected by the mode switch 3, the code transfer instruction unit 23 of the computation unit 2 does not transmit a code storage instruction 37 to the outer code storage device 25. Accordingly, in the normal mode, neither the test process code 15 nor the APL test process code 17 are transferred to the code storage device 4 and stored therein.

Similarly to the first embodiment, the code transfer instruction unit 23 of the computation unit 2 transmits, to the code storage device 4, a base process code transfer instruction 31 to transfer the base process code 14 to the main memory 5, and further transmits, to the code storage device 4, an APL process code transfer instruction 32 to transfer the APL process code 16 to the main memory 5.

Upon reception of the base process code transfer instruction 31, the code storage device 4 transfers the base process code 14 to the main memory 5. Further, upon reception of the APL process code transfer instruction 32, the code storage device 4 transfers the APL process code 16 to the main memory 5. When the transfer of the base process code 14 and the APL process code 16 to the main memory 5 is finished, the code execution unit 24 of the computation unit 2 reads the base process code 14 and the APL process code 16 and carries out the aforementioned normal process of the controlled target device 10 by use of these codes. It is noted that, when the mode is changed in the mode switch 3, the codes transferred from the outer code storage device 25 and stored in the code storage device 4 are deleted.

(Effect)

According to the third embodiment of the present invention, codes to be used only for the test process and the APL test process are stored in the outer code storage device 25, and only when the test mode or the APL test mode are selected, these codes are transferred to the code storage device 4 and stored therein. This makes it possible to prevent the codes to be used only for the test process and the APL test process from being transferred to the main memory 5 and being used in the normal mode.

Note that it goes without saying that embodiments of the present invention are not limited to the embodiments described above. For example, as for dividing of the code storage device 4 into the base process code storage region 11 and the APL process code storage region 12, if a storage position of a code is able to be directly indicated by the boot process code 13 without dividing of regions, it is possible to omit the dividing of regions in the code storage device 4. Similarly, as for dividing of the main memory 5 into the base process code transfer region 21 and the APL process code transfer region 22, if the code execution unit 24 of the computation unit 2 is able to distinguish the base process code 14 and the APL process code 16 and read them without dividing of regions, it is possible to omit the dividing of regions in the main memory 5.

Further, in a case where one controlled target devices 10 is connected to the digital control device 1 and allocation of test process outputs 35 by the I/O bus 6 and collection of test process inputs 36 by the I/O bus 6 are not necessary, or the like case, it is possible to omit the configuration of the I/O bus 6. Further, in a case where the code execution unit 24 of the computation unit 2 is able to transmit a test process output 35 in a signal form which the controlled target device 10 is able to receive directly, and to directly receive a test process input 36 transmitted from the controlled target device 10, or the like case, it is possible to omit the configuration of the signal I/O device 7.

Further, in a case where the digital control device 1 is changed into the test mode from a state where the digital control device 1 operates in the normal mode, or in a case where the digital control device 1 is changed into the normal mode from a state where the digital control device 1 operates in the test mode, the digital control device 1 may be configured such that power activation is carried out not only by the boot process constituted by a starting process and a code transfer process by using the boot process code 13 again, but also by mode selection, so that when the mode switch 3 is changed, restart of the digital control device 1 and reset of a power source may be carried out.

Further, in a case where a mode is changed without initialization and the starting process while power activation is carried out, a function to erase codes transferred into the main memory 5 is newly provided, and after the codes transferred into the main memory 5 is erased by changing of the mode in the mode switch 3 as a trigger, the code transfer process is newly carried out according to the boot process code 13.

Further, in a case where a mode of the mode switch 3 is selected after power activation of the digital control device 1, the code transfer instruction unit 23 in the computation unit 2 starts the code transfer process upon reception of a mode select signal 41 after a mode is selected by the mode switch 3.

Further, in a case where, in the normal mode and the test mode, the normal process and the test process of the controlled target device 10 is performable according to sequence control by use of all contents of the APL process code 16, it is possible to omit the configuration of the maintenance tool 9 for further specifying a process content from the APL process code 16.

Some embodiments of the present invention have been described above, but these embodiments are merely described as examples and are not intended to limit a scope of the invention. These new embodiments can be carried out in other various configurations, and various omissions, substitutions, modifications, and combinations of features of respective embodiments can be carried out without departing from a concept of the invention. These embodiments and the modifications thereof are included in the scope and concept of the invention, and are included within inventions described in Claims and their equivalent ranges.

### DESCRIPTION OF REFERENCE NUMERALS

1 . . . digital control device
2 . . . computation unit
3 . . . mode switch
4 . . . code storage device
5 . . . main memory
6 . . . I/O bus
7 . . . signal I/O device
8 . . . boot process code storage memory
9 . . . maintenance tool
10 . . . controlled target device
11 . . . base process code storage region
12 . . . APL process code storage region
13 . . . boot process code
14 . . . base process code
15 . . . test process code
16 . . . APL process code
17 . . . APL test process code
21 . . . base process code transfer region
22 . . . APL process code transfer region
23 . . . code transfer instruction unit
24 . . . code execution unit
25 . . . outer code storage device
31 . . . base process code transfer instruction
32 . . . APL process code transfer instruction
33 . . . normal process output
34 . . . normal process input
35 . . . test process output
36 . . . test process input
37 . . . code storage instruction
41 . . . mode select signal
42 . . . process content specification signal
51 . . . remote I/O control substrate
52 . . . I/O substrate
53 . . . sensor
56 . . . transmission substrate
57 . . . external computation device
61 . . . actuator

1. A digital control device comprising:
a mode switch capable of selecting either of a normal mode for carrying out a normal process and a test mode for carrying out a test process;
a code storage device for storing a base process code, an application process code for controlling the normal process, and a test process code for controlling the test process;
a main memory capable of receiving and storing codes transferred from the code storage device;
a boot process code storage memory for storing a boot process code indicative of a code to be transferred from the code storage device to the main memory in each of the normal mode and the test mode; and
a computation unit for reading the boot process code from the boot process code storage memory after power activation, wherein:
when the normal mode is selected by the mode switch, the computation unit causes the base process code and the application process code to be transferred to the main memory by use of the boot process code, so that the computation unit reads the base process code and the application process code thus transferred to the main memory and carries out the normal process, and
when the test mode is selected by the mode switch, the computation unit causes the base process code and the test process code to be transferred to the main memory by use of the boot process code, so that the computation unit reads the base process code and the test process code thus transferred to the main memory and carries out the test process.

2. A digital control device comprising:
a mode switch capable of selecting either of a normal mode for carrying out a normal process or a test mode for carrying out a test process;
a code storage device for storing a base process code and an application process code for controlling the normal process;
a main memory capable of receiving and storing codes transferred from the code storage device;
a boot process code storage memory for storing a boot process code indicative of a code to be transferred from the code storage device to the main memory in each of the normal mode and the test mode;
a computation unit for reading the boot process code from the boot process code storage memory after power activation; and
an outer code storage device capable of storing a test process code for controlling the test process and transferring the test process code to the code storage device so that the test process code is stored in the code storage device, wherein:
when the normal mode is selected by the mode switch, the computation unit causes the base process code and the application process code to be transferred to the main memory by use of the boot process code, so that the computation unit reads the base process code and the application process code thus transferred to the main memory and carries out the normal process, and
when the test mode is selected by the mode switch, the computation unit causes the outer code storage device to transfer the test process code to the code storage device so that the test process code is stored therein, and causes the test process code transferred to and stored in the code storage device and the base process code stored in the code storage device in advance to be transferred to the main memory, so that the computation unit reads the base process code and the test process code thus transferred to the main memory and carries out the test process.

3. The digital control device according to claim 2, wherein:
when the normal mode is selected after the test mode is selected by the mode switch, the computation unit erases, from the code storage device, the test process code transferred to and stored in the code storage device.

4. The digital control device according to claim 1, wherein:
the code storage device further stores an application test process code;
the boot process code further indicates a storage region of the application test process code within the code storage device;
the mode switch is able to select any of the normal mode, the test mode, and an application test mode; and
when the application test mode is selected by the mode switch, the computation unit causes the application test process code and the base process code to be transferred to the main memory by use of the boot process code, so that the computation unit reads the base process and the test process code thus transferred to the main memory and carries out the test process.

5. The digital control device according to claim 2, wherein
the outer code storage device stores an application test code,
the boot process code indicates a storage area of the application test process code in the code storage device,
the mode switch can select either of the normal mode, the test mode, or an application test mode, to be transferred;
when the application test mode is selected by the mode switch, the computation unit causes the outer code storage device to transfer the test process code stored in the outer code storage device to the code storage device so that the test process code is stored therein, and causes the test process code thus transferred to and stored in the code storage device and the base process code stored in the code storage device in advance to be transferred to the main memory, so that the computation unit reads the base process code and the test process code thus transferred to the main memory and carries out the test process by use of the base process code and the test process code; and
when the test mode is selected by the mode switch, the computation unit causes the outer code storage device to transfer the application test process code to the code storage device so that the application test process code is stored therein, and causes the application test process code thus transferred to and stored in the code storage device and the base process code and the application process code stored in the code storage device in advance to be transferred to the main memory, so that the computation unit reads the application test process code, the base process code, and the application process code thus transferred to the main memory and carries out the application test process by use of the application test process code, the base process code, and the test process code.

6. The digital control device according to claim 5, wherein:
when the normal mode is selected after the test mode is selected by the mode switch, the computation unit erases, from the code storage device, the test process code transferred to and stored in the code storage device; and
when the normal mode is selected after the application test mode is selected by the mode switch, the computation unit erases, from the code storage device, the application test process code transferred to and stored in the code storage device.

7. The digital control device according to claim 1, further comprising a function to erase a code stored in the main memory when a mode is changed by the mode switch.

8. An execution method of a digital control device, comprising:
a step of selecting, by a mode switch, either of a normal mode for carrying out a normal process and a test mode for carrying out a test process;
a step of, when the normal mode is selected by the mode switch, a computation unit causing a base process code and an application process code for controlling the normal process to be transferred to a main memory from a code storage device so as to carry out the normal process by reading the base process code and the application process code thus transferred to the main memory; and
a step of, when the test mode is selected by the mode switch, the computation unit causing the base process code and a test process code for controlling the test process, to be transferred to the main memory from the code storage device so as to carry out the test process by reading the base process code and the test process code thus transferred to the main memory.

9. The digital control device according to claim 2, further comprising a function to erase a code stored in the main memory when a mode is changed by the mode switch.
